(19) United States
(12) Patent Application Publication
(10) Pub. No.: US 2026/0148025 A1
(43) Pub. Date: May 28, 2026

(54) SYSTEM FOR LINKING NON-NETWORK SENSOR AND EQUIPMENT INFORMATION COLLECTION IN INDUSTRIAL SITE AND METHOD FOR OPERATING SAME

(71) Applicant: ECOSIAN CO., LTD., Seoul (KR)

(72) Inventors: Tae Dong LEE, Seoul (KR); Won Jang PARK, Seoul (KR); Min Ho CHOI, Goyang-si (KR); Moo Kyung SEO, Seoul (KR); Han Sung CHOI, Seoul (KR); Hye Mi LIM, Incheon (KR); So Jeong PARK, Seoul (KR); So Yeon PARK, Seoul (KR); Ki Bum HAN, Seoul (KR)

(21) Appl. No.: 19/094,964

(22) Filed: Mar. 30, 2025

(30) Foreign Application Priority Data
Nov. 28, 2024 (KR) 10-2024-0172985
Dec. 2, 2024 (KR) 10-2024-0176273

(51) Int. Cl. G06K 7/14; G06F 16/955

(52) U.S. Cl. CPC G06K 7/1417; G06F 16/9554

(57) ABSTRACT

A system for linking non-network sensor and equipment information collection in industrial site according to one embodiment of the present disclosure to address the issues comprises a field manager terminal configured access a web uniform resource locator (URL) by scanning a quick-response (QR) code attached to the non-network field equipment through an open application programming interface (API) and then provide QR code scan information and equipment management information obtained by photographing and recording management status including image and text of the non-network field equipment; and a non-network field equipment information collection linkage server configured to be linked to an equipment data management system via a network and analyze and determine operation status and management status of the field equipment using a deep learning algorithm based on the equipment management information provided by the field manager terminal.

### GOVERNMENT SUPPORT CLAUSE

This invention was made with support from the National R&D Program funded by the Ministry of Trade, Industry and Energy (MOTIE) of the Republic of Korea, under Project Number 2022202090003A. The research was managed by the Korea Institute of Energy Technology Evaluation and Planning (KETEP) as part of the “Core Technology Development for Energy Demand Management” program. The research project, titled “Development and Demonstration of an Integrated Energy-Environment Management System (EEMS) for Manufacturing and Environmental Facilities Linked to Production Information,” was conducted by ECOSIAN CO., LTD. during the period from Jan. 1, 2023, to Dec. 31, 2023.

### CROSS-REFERENCE TO RELATED APPLICATION(S)

This application claims priority to Korean Patent Application Nos. 10-2024-0172985, filed on Nov. 28, 2024, and 10-2024-0176273, filed on Dec. 2, 2024, in the Korean Intellectual Property Office, the disclosures of which are incorporated by reference herein in their entireties.

### TECHNICAL FIELD

The present disclosure relates to a system for linking non-network sensor and equipment information collection in industrial site and a method for operating the same.

### DISCUSSION OF RELATED ART

Industrial sites emphasize the need for measurement and management of equipment status data, but for non-networked facilities and sensors, there was a database-based equipment input support system in which field managers simply entered field data by text.

Therefore, this disclosure discloses a technology that enables information collection regardless of the on-site equipment expertise of the on-site personnel by checking the surrounding location of the equipment and sensors through the location information of the equipment and sensors using the global positioning system (GPS) inside the site, and finally checking it with the QR code attached to each equipment and sensor, entering information of the equipment, and replacing the input in the form of text with video shooting in the field.

### SUMMARY

An object of the present disclosure is to provide aa system for linking non-network sensor and equipment information collection in industrial site and a method for operating the same, that may address the conventional issues.

A system for linking non-network sensor and equipment information collection in industrial site according to one embodiment of the present disclosure to address the issues comprises a field manager terminal configured access a web uniform resource locator (URL) by scanning a quick-response (QR) code attached to the non-network field equipment through an open application programming interface (API) and then provide QR code scan information and equipment management information obtained by photographing and recording management status including image and text of the non-network field equipment; and a non-network field equipment information collection linkage server configured to be linked to an equipment data management system via a network and analyze and determine operation status and management status of the field equipment using a deep learning algorithm based on the equipment management information provided by the field manager terminal.

In an embodiment, the open API includes: a camera shooting unit configured to link with a camera of the field manager terminal to support a function for improving quality of an image of the field equipment taken by the camera; a QR scan recognition unit configured to scan the QR code attached to the field equipment and recognize global positioning system (GPS) coordinate information, resource information, and web URL address of the field equipment by the scan information; a web access unit configured to access the web URL address recognized by the QR scan recognition unit and support a data transmission path between the field manager terminal and the non-network field equipment information collection linkage server; a data input unit configured to support a function for entering management status information of the field equipment to which a QR code sticker is attached; and a GPS location notification unit configured to display and notify a location of the field equipment located within a preset radius from a location of the field manager terminal.

In an embodiment, the non-network field equipment information collection linkage server includes: a field equipment registration unit configured to register the type and GPS information of the non-network field equipment input by the field manager terminal; a QR code generation and issuance unit configured to identify or recognize the non-network field equipment and generate and issue the QR code in which a URL, which is a data transmission path for transmitting management status information of the non-network field equipment, is recorded; a field data linkage unit configured to collect identification information of the QR code attached to the non-network field equipment transmitted from the field manager terminal and management status information including image and text of the non-network field equipment; a data organization and analysis unit configured to evaluate and analyze the management status of the non-network field equipment based on the management status information of the non-network field equipment collected by the field data linkage unit; and a legacy system linkage unit configured to transmit the evaluation and analysis results of the data analysis unit to an equipment data management system.

In an embodiment, the field manager terminal prints the QR code issued by the QR code generation and issuance unit as a sticker.

In an embodiment, the QR code generation and issuance unit includes a QR code generation unit configured to generate a QR code in which GPS information and resource information of the field equipment registered in the field equipment registration book are recorded; and a QR code issuance unit configured to issue the QR code generated by the QR code generation unit to the field manager terminal that manages the field equipment.

In an embodiment, the field data linkage unit includes a data collection unit configured to collect the QR code scan information transmitted from the field manager terminal and management status information of the non-network field equipment; a data verification unit configured to identify and verify field equipment GPS information and resource information in the QR code scan information collected by the data collection unit; and a data classification unit configured to classify the management status information of the non-network field equipment into images and texts.

In an embodiment, the data organization and analysis unit includes: an equipment list management unit that calls a field management list registered in the equipment data management system through the legacy system linkage unit; a data analysis and determination configured to diagnose the normal or abnormal state of the field equipment based on a deep learning algorithm based on an image taken of the operation status or management status of the field equipment; and an evaluation and diagnosis unit configured to comprehensively evaluate and diagnose the management status of the field equipment based on the analysis results of an image analysis and text analysis.

In an embodiment, the legacy system linkage unit is configured to transmit the comprehensive evaluation diagnosis results from the data organization and analysis unit to the equipment data management system, which is a legacy system, and, when receiving the call of the equipment management list from the data analysis and determination unit, call and receive a field data linkage list from the linked equipment data management system, and transmit the equipment management list from the received field data linkage list to the data analysis and determination unit.

A method for operating a system for linking non-network sensor and equipment information collection in industrial site according to one embodiment of the present disclosure to address the issues comprises, in a field manager terminal, accessing a web uniform resource locator by scanning a QR code attached to the non-network field equipment and then providing the QR code scan information and equipment management information obtained by photographing and recording management status including image and text of the non-network field equipment; and, in a non-network field equipment information collection linkage server, linking to an equipment data management system via a network and analyzing and determining operation status and management status of the field equipment using a deep learning algorithm based on the equipment management information provided by the field manager terminal, and then transmitting the result to the equipment data management system.

There are many requirements for collecting and managing field data in various industrial sites. The use of an industrial site non-network sensor/equipment information collection linkage system and method according to one embodiment of the present disclosure has the advantage of enabling easier collection of field data through a standardized basis for analog equipment/sensors that are not connected to a network and digital equipment/sensor equipment that does not include communication, thereby contributing to work efficiency and digitalization of industrial sites.

In addition, it has the advantage of standardizing the on-site non-network sensor/equipment data collection/management system to enable compatibility/interoperability with existing legacy systems to build a separate system, thereby minimizing the need for conversion.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a network configuration diagram of a system for linking non-network sensor and equipment information collection in industrial site according to one embodiment of the present disclosure;

FIG. 2 is a configuration diagram of the open API of the field manager terminal illustrated in FIG. 1;

FIG. 3 is a device configuration diagram of the non-network field equipment information collection linkage server illustrated in FIG. 1;

FIG. 4 is a device configuration diagram of the field data linkage unit illustrated in FIG. 3;

FIG. 5 is a detailed configuration diagram of the data analysis and determination unit illustrated in FIG. 3;

FIG. 6 is an example diagram of the convolutional neural network (CNN) architecture applied in the image analysis illustrated in FIG. 5;

FIG. 7 is an example diagram of the architecture of the faster regions with CNN (R-CNN) model applied in the image analysis unit illustrated in FIG. 5;

FIG. 8 is a flow chart explaining a method for operating a system for linking non-network sensor and equipment information collection in industrial site according to one embodiment of the present disclosure;

FIG. 9 is a diagram explaining the process of initial equipment registration in the non-network information collection/linkage system according to one embodiment of the present disclosure; and

FIG. 10 is a diagram explaining the process of equipment operation in the non-network information collection/linkage system according to one embodiment of the present disclosure.

### DETAILED DESCRIPTION OF EXEMPLARY EMBODIMENTS

Certain structural or functional descriptions of embodiments of the invention disclosed in this specification or application are exemplified for the purpose of illustrating embodiments in accordance with the invention only, and embodiments in accordance with the invention may be implemented in various forms. Accordingly, they should not be construed as limiting to the embodiments described herein or in the application.

Embodiments according to the present disclosure are subject to various modifications and can take many forms. Accordingly, certain embodiments are illustrated in the drawings and described in detail in the specification or application. However, this is not intended to limit the present disclosure to specific embodiments, and it should be understood that it includes all modifications, equivalents or substitutes included in the spirit and scope of the present disclosure.

Terms such as “first” and/or “second” may be used to describe various components, but the components should not be limited by the terms. The terms are used solely for the purpose of distinguishing one component from another, e.g. a first component may be named as a second component, and similarly a second component may be named as a first component, without departing from the scope of the rights in accordance with the concept of the invention.

It is understood that when an element is referred to as being “connected” or “coupled” to another element, it may be directly connected or coupled to the other element, but other elements may exist in the middle. On the other hand, when an element is referred to as “directly connected” or “directly connected” to another element, it should be understood that no intervening element exists. Other expressions that describe relationships between components, such as “between” and “directly between” or “adjacent to” and “directly adjacent to,” should be interpreted similarly.

Terms used in this specification are only used to describe specific embodiments and are not intended to limit the present disclosure. Singular expressions include plural expressions unless the context clearly dictates otherwise. It should be understood that as used herein, terms such as “comprise” or “have” are intended to designate that there is a feature, number, step, operation, component, part, or combination thereof described in the specification, but do not preclude the existence or addition of one or more other features, numbers, steps, operations, components, parts, or combinations thereof.

Unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in this specification, it is not to be construed in an ideal or overly formal sense.

Hereinafter, a system for linking non-network sensor and equipment information collection in industrial site according to an embodiment of the present disclosure will be described in more detail based on the accompanying drawings.

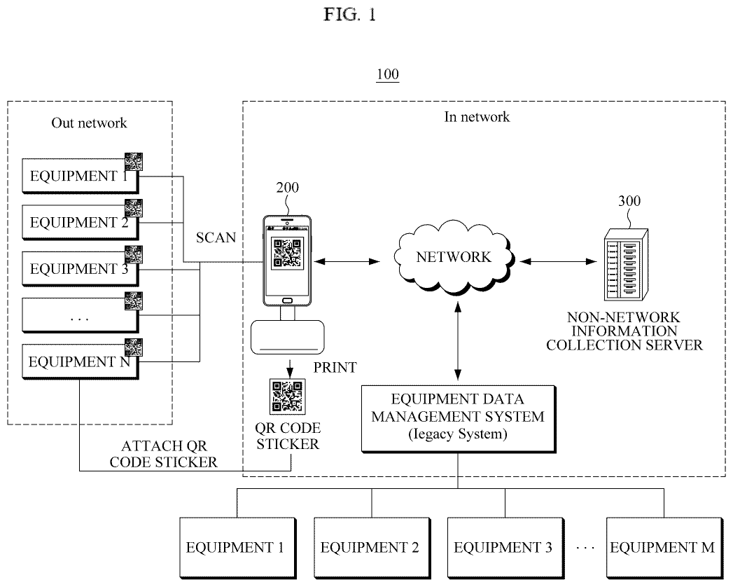

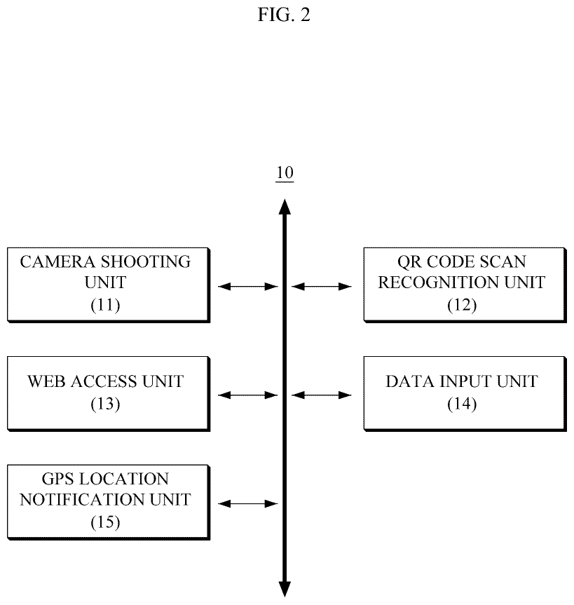

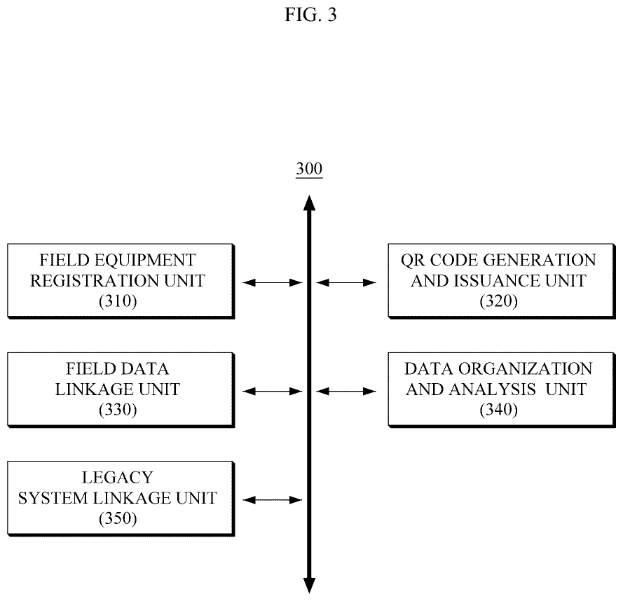

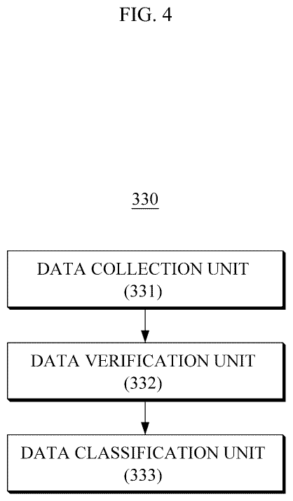

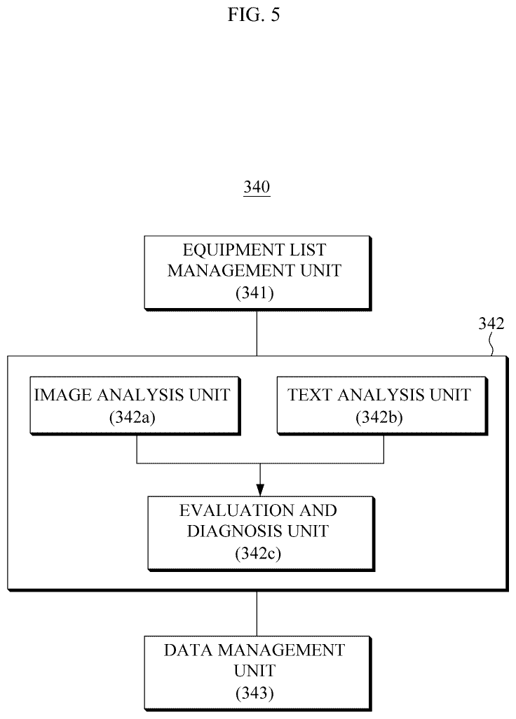

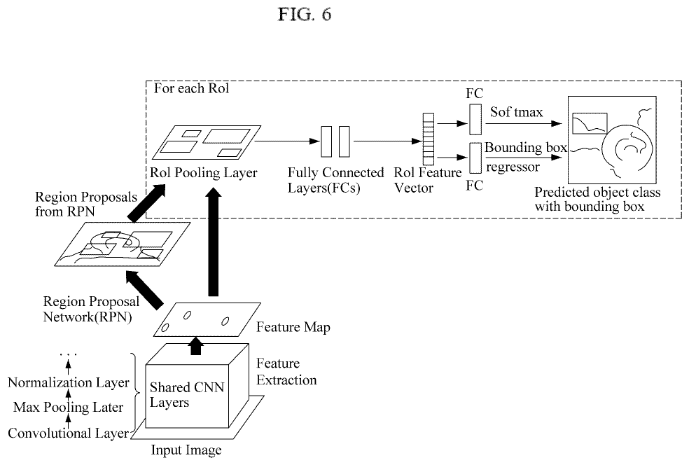

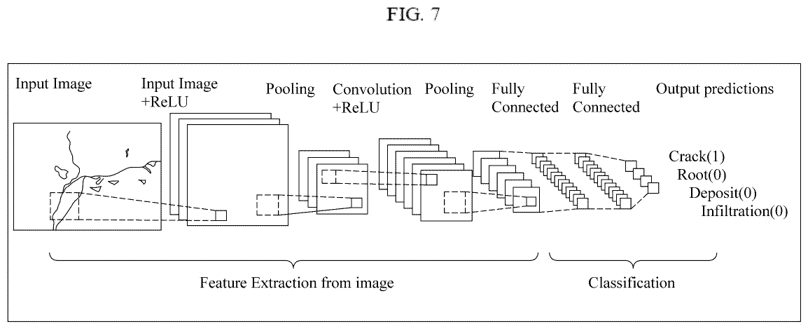

FIG. 1 is a network configuration diagram of a system for linking non-network sensor and equipment information collection in industrial site according to one embodiment of the present disclosure, FIG. 2 is a configuration diagram of the open API of the field manager terminal illustrated in FIG. 1, FIG. 3 is a device configuration diagram of the non-network field equipment information collection linkage server illustrated in FIG. 1, FIG. 4 is a device configuration diagram of the field data linkage unit illustrated in FIG. 3, FIG. 5 is a detailed configuration diagram of the data analysis and determination unit illustrated in FIG. 3, FIG. 6 is an example diagram of the CNN architecture applied in the image analysis illustrated in FIG. 5, and FIG. 7 is an example diagram of the architecture of the faster R-CNN model applied in the image analysis unit illustrated in FIG. 5.

First, as illustrated in FIG. 1, the system for linking non-network information collection in industrial site 100 according to one embodiment of the present disclosure includes a field manager terminal 200 and a non-network field equipment information collection linkage server 300.

Each component communicates over a network that refers to a connection structure that enables information exchange between nodes, such as a plurality of terminals and servers, and the network means a connection structure that enables information exchange between each node, such as multiple terminals and servers. Examples of such networks include radio frequency (RF), 3rd generation partnership project (3GPP) network, long term Evolution (LTE) network, 5rd generation partnership project (5GPP) network, world interoperability for microwave access (WIMAX) network, Internet, local area network (LAN), wireless local area network (wireless LAN), wide area network (WAN), personal area network (PAN), Bluetooth network, near field communication (NFC) network, satellite broadcasting network, analog broadcasting network, digital multimedia broadcasting (DMB) network, etc., but are not limited thereto.

It will be clear that in the following, the term “at least one” is defined as a term including singular and plural, and even if the term “at least one” does not exist, each component may be present in singular or plural, and it can mean singular or plural. Further, each component is provided in singular or plural, which can be changed according to the embodiment.

The field manager terminal 200 may be configured to connect to a non-network field equipment information collection linkage server 300 using an Open API to provide image information and text information on the management status of non-network field equipment deployed at an industrial site.

In addition, the field manager terminal 200 may be configured to request a QR code for identifying a non-network field equipment and verifying the location of the non-network field equipment using an Open API, to a non-network field equipment information collection linkage server 300, and when the location information and resource information of the corresponding field equipment are registered in the non-network field equipment information collection linkage server 300, receive the issuance of the QR code in which the location information and resource information of the field equipment are recorded, and process and print out the QR code as an attachable QR code sticker.

At this time, the field manager terminal 200 may be a terminal combined with a printing means capable of printing out a QR code sticker.

The field manager terminal 200 may include a laptop, desktop, etc. The field manager terminal 200 may for example, include all kinds of handheld-based wireless communication devices such as personal communication system (PCS), global system for mobile communications (GSM), personal digital cellular (PDC), personal handyphone system (PHS), personal digital assistant (PDA), international mobile telecommunication (IMT)—2000, code division multiple access (CDMA)—2000, W-code division multiple access (W-CDMA), wireless broadband internet (Wibro) terminal, smartphone, smart pad, and tablet PC. as a wireless communication device that ensures portability and mobility,

More specifically, the open API 10 installed in the field manager terminal 200 may include a camera shooting unit 11, a QR code scan recognition unit 12, a web access unit 13, a data input unit 14, and a GPS location notification unit 15.

The camera shooting unit 11 may be configured to linking with the camera of the field manager terminal 200 to support a function for improving the image quality of a field equipment shooting image captured by the camera.

The QR code scan recognition unit 12 may be configured to scan the QR code attached to the field equipment and recognize GPS coordinate information, resource information, and web URL address of the field equipment from the scan information.

The web access unit 13 may be configured to access the web URL address recognized by the QR code scan recognition unit 12 to support a data transmission path between the field manager terminal 200 and a non-network field equipment information collection linkage server 300.

The data input unit 240 may be configured to support a function for inputting management status information of field equipment to which a QR code sticker is attached.

Here, the management status information of field equipment includes image information taken of the operation status of field equipment and text information on the operation status of field equipment entered by the field manager.

The GPS location notification unit 15 may be configured to display and notify the location of the field equipment located within a preset radius from the location of the field manager terminal.

Therefore, the field manager terminal 200 can easily check the location information of the field equipment with the QR code sticker attached through the open API 10 and can easily provide management information recording the operation management status of the field equipment in the form of image and text.

Next, the non-network field equipment information collection linkage server 300 may be configured to link to an equipment data management system via a network and analyze and determine operation status and management status of the field equipment using a deep learning algorithm based on the equipment management information provided by the field manager terminal, and then transmit the result to the equipment data management system.

For reference, the non-network field equipment information collection linkage server 300 may communicate with the equipment data management system via a network.

More specifically, the non-network field equipment information collection linkage server (300) includes a field equipment registration unit 310, a QR code generation and issuance unit 320, a field data linkage unit 330, a data organization and analysis unit 340, and a legacy system linkage unit 350.

The field equipment registration unit 310 may be configured to register the type and GPS information of non-network field equipment entered in the field manager terminal 200.

The QR code generation and issuance unit 320 may be configured to identify or recognize the non-network field equipment and generate and issue the QR code in which a URL, which is a data transmission path for transmitting management status information of the non-network field equipment, is recorded.

The field data linkage unit 330 may be configured to collect, classify, and manage the identification information of the QR code attached to the non-network field equipment transmitted from the field manager terminal 200 and the management status information including image and text of the non-network field equipment.

More specifically, the field data linkage unit 330 may include a data collection unit 331, a data verification unit 332, and a data classification unit 333.

The data collection unit 331 may be configured collect the GPS location coordinates, resource information, and equipment management status information including image and text of the non-network field equipment transmitted from the field manager terminal 200 accessed through a web URL address.

The data verification unit 332 may be a configured to call the QR code information collected from the data collection unit 331 and the equipment management list from the data analysis and determination unit 340 to check whether the corresponding field equipment is present in the equipment management list.

The data classification unit 333 may be configured to classify the management status information of the field equipment collected by the data collection unit 310 into images and texts when the field equipment is determined to be a management target of the equipment management list by the data verification unit 332.

Next, the data organization and analysis unit 340 may be configured to evaluate and analyze the management status of the field equipment based on the management status information including image and text of the non-network field equipment collected by the field data linkage unit 330.

More specifically, the data organization and analysis unit 340 may include an equipment list management unit 341, a data analysis and determination unit 342, and a data management unit 343.

The equipment list management unit 341 may be configured to call the field management list registered in the equipment data management system through the legacy system linkage unit 350.

The data analysis and determination unit 342 may be configured to diagnose the normal or abnormal state of the field equipment based on a deep learning algorithm based on an image taken of the operation status or management status of the field equipment.

The data analysis and determination unit 342 includes an image analysis unit 342a, a text analysis unit 342b, and an evaluation and diagnosis unit 342c.

The image analysis unit 342a may sample using the management status image of the field equipment, and then perform data preprocessing and augmentation on the sampled image. At this time, training of the detection neural network model, training of the data generation model, data generation, etc. are implemented, and then the neural network model is transferred to learn the augmented sample image. At this time, the data generation model neural network can be trained using the detection neural network to newly generate a large amount of defect image data, and this is stored in the database unit. In other words, by newly generating and storing the defect image, there is an effect of continuously increasing the performance of the learned detection neural network model.

Further, in order to specify the area corresponding to the part of the field equipment or the observation target included in the image of the received image file or video file, the object area is extracted using the region proposal network (RPN).

Further, in order to recognize the object in the extracted object area as a single object, the R-CNN algorithm, a deep learning algorithm, is used to learn and compare it with several objects in the database, and if the object in the image is recognized as an object in the database unit, the name result of the recognized object is saved back in the database unit to upgrade the learning result. The saved result is saved as a new learning that upgrades the R-CNN algorithm. After that, the transfer-learned detection algorithm is selected and applied.

The RPN that specifies the object area and the faster R-CNN, an algorithm that recognizes a specific object, can be combined into a single network to perform object recognition more quickly.

In other words, the time required for many operations that occur by comparing objects in the image with various information stored in the database unit for object recognition can be reduced, and the presence of defects and the type and location of defects can be recognized much faster than the existing method.

Further, the selected detection algorithm is applied to classify the type of defect, identify the location of the defect, and provide the identified type and location information of the defect. At this time, this is interpreted to include any technical configuration that can output information about the type of defect and the location of the defect as visible data.

Meanwhile, a convolutional neural network is used to extract features from the management status image of the field equipment, a feature map is generated in the last layer, the RPN generates region proposals with various aspect ratios and scales based on the feature map, and the generated region proposals can be provided to a high-speed R-CNN detector for classification and bounding box regression.

For reference, deep Learning, a transfer learning algorithm used in the image analysis unit 342a, is a technology used to cluster or classify objects or data. It is a technology that inputs a large amount of data into a computer and classifies similar data into groups.

Many machine learning algorithms have already emerged to solve the problem of how to classify data. Deep learning is a machine learning method that has been proposed to overcome the limitations of artificial neural networks.

The algorithms of deep learning technology include CNNs for image recognition. These are algorithms that automatically learn features from data.

Deep learning techniques have been extensively developed and applied in various fields through deep learning architectures, of which CNNs can be applied to a deep learning-based device according to one embodiment.

In order to learn data through machine learning, it is necessary to first process raw data (pixel-level data) into features (lines, faces, grains) with a higher level of abstraction, and deep learning techniques, in particular CNN, efficiently learn these features from the data. This is an illustrative diagram of a CNN architecture according to one embodiment of the present disclosure.

A CNN model outputs a result for an input after processing it through a stack of layers that includes convolution, activation, pooling, normalization, and fully connectivity. Compared to traditional approaches, CNN has the advantage of requiring less image preprocessing and extracting features through learning, eliminating the need for expertise in manual design of feature extractors.

Additionally, R-CNN is used to accurately identify major objects in an image by expressing them as bounding boxes. This uses image data as input, displays regions as boxes (bounding boxes), and outputs a form of labeling (class label) for each object. In other words, this is a method of first proposing region candidates where objects are likely to be in the image and assigning scores to recognize objects.

Next, the text analysis unit 342b may be configured to analyze keywords in the management status text information of field equipment input from the field manager terminal 200 to diagnose the management status of field equipment.

In addition, the evaluation and diagnosis unit may be configured to comprehensively evaluate and diagnose the management status of field equipment based on the analysis results of the image analysis unit 342a and the text analysis unit 342b.

Next, the legacy system linkage unit 350 may be configured to transmit the comprehensive evaluation and diagnosis results from the data organization and analysis unit 340 to the equipment data management system, which is a legacy system.

In addition, when receiving a call of an equipment management list from the data analysis and determination unit 340, it may be configured to call and receive the field data linkage list from the linked equipment data management system, and transmit the equipment management list from the received field data linkage list to the data analysis and determination unit 340.

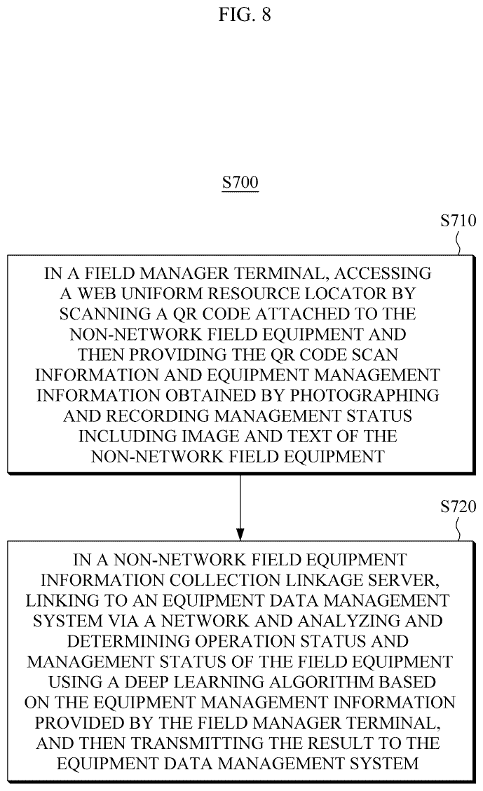

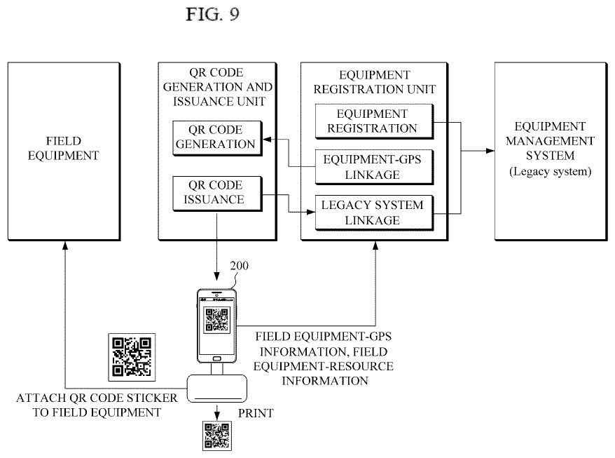

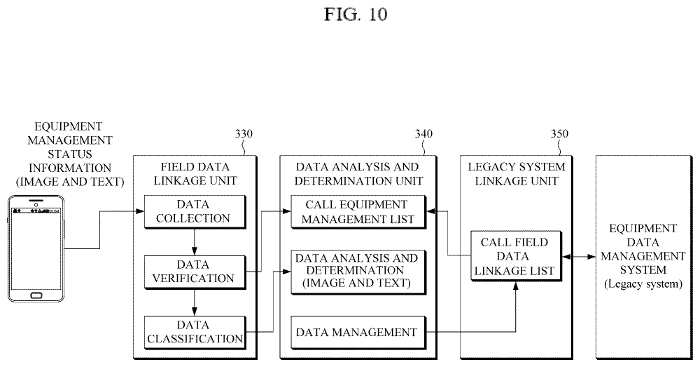

FIG. 8 is a flow chart explaining a method for operating a system for linking non-network sensor and equipment information collection in industrial site according to one embodiment of the present disclosure, FIG. 9 is a diagram explaining the process of initial equipment registration in the non-network information collection/linkage system according to one embodiment of the present disclosure, and FIG. 10 is a diagram explaining the process of equipment operation in the non-network information collection/linkage system according to one embodiment of the present disclosure.

Referring to FIGS. 8, 9, and 10, a method for operating a system for linking non-network sensor and equipment information collection in industrial site S700 according to one embodiment of the present disclosure comprises the steps of, in a field manager terminal, accessing a web uniform resource locator by scanning a QR code attached to the non-network field equipment and then providing the QR code scan information and equipment management information obtained by photographing and recording management status including image and text of the non-network field equipment S710; and, in a non-network field equipment information collection linkage server, linking to an equipment data management system via a network and analyzing and determining operation status and management status of the field equipment using a deep learning algorithm based on the equipment management information provided by the field manager terminal, and then transmitting the result to the equipment data management system S720.

The non-network field equipment information collection linkage server 300 may communicate with the equipment data management system via a network.

The non-network field equipment information collection linkage server 300 may be configured to register the type and GPS information of non-network field equipment entered in the field manager terminal 200.

Further, it may be configured to identify or recognize the non-network field equipment and generate and issue the QR code in which a URL, which is a data transmission path for transmitting management status information of the non-network field equipment, is recorded;

Further, it may be configured to collect, classify, and manage identification information of the QR code attached to the non-network field equipment transmitted from the field manager terminal 200 and management status information including image and text of the non-network field equipment.

Further, it may be configured collect the GPS location coordinates, resource information, and equipment management status information including image and text of the non-network field equipment transmitted from the field manager terminal 200 accessed through a web URL address.

Further, it may be a configured to call the QR code information collected and the equipment management list from the data analysis and determination unit 340 to check whether the corresponding field equipment is present in the equipment management list.

Further, when the field equipment is determined to be a management target of the equipment management list, it may be configured to classify the management status information of the field equipment collected by the data collection unit 310 into images and texts.

Further, it may be configured to evaluate and analyze the management status of the field equipment based on the collected management status information including image and text of the non-network field equipment.

Further, it may be configured to call the field management list registered in the equipment data management system through the legacy system linkage unit 350.

Further, it may be configured to diagnose the normal or abnormal state of the field equipment based on a deep learning algorithm based on an image taken of the operation status or management status of the field equipment.

In addition, it may be configured to comprehensively evaluate and diagnose the management status of field equipment based on the analysis results of the image analysis unit 342a and the text analysis unit 342b.

The legacy system linkage unit 350 may be configured to transmit the comprehensive evaluation and diagnosis results from the data organization and analysis unit 340 to the equipment data management system, which is a legacy system.

In addition, when receiving a call of an equipment management list from the data analysis and determination unit 340, it may be configured to call and receive the field data linkage list from the linked equipment data management system, and transmit the equipment management list from the received field data linkage list to the data analysis and determination unit 340.

There are many requirements for collecting and managing field data in various industrial sites. The use of an industrial site non-network sensor/equipment information collection linkage system and method according to one embodiment of the present disclosure has the advantage of enabling easier collection of field data through a standardized basis for analog equipment/sensors that are not connected to a network and digital equipment/sensor equipment that does not include communication, thereby contributing to work efficiency and digitalization of industrial sites.

In addition, it has the advantage of standardizing the on-site non-network sensor/equipment data collection/management system to enable compatibility/interoperability with existing legacy systems to build a separate system, thereby minimizing the need for conversion.

The term “unit” used in one embodiment of the present disclosure may be implemented as a hardware component, a software component, and/or a combination of hardware components and software components. For example, devices and components described in the embodiments may be implemented using, for example, a processor, a controller, an arithmetic logic unit (ALU), a digital signal processor, a microcomputer, a field programmable array (FPA), or one or more general purpose or special purpose computers, such as any other device capable of executing and responding to instructions. The processing device may execute an operating system (OS) and one or more software applications running on the operating system. Further, the processing device may access, store, manipulate, process, and generate data in response to execution of software. For convenience of understanding, there are cases in which one processing device is used, but those skilled in the art will understand that the processing device includes a plurality of processing elements and/or a plurality of types of processing elements. For example, a processing device may include a plurality of processors or a processor and a controller. It may also include other processing configurations, such as parallel processors.

Software may include a computer program, program code, instructions, or some combination thereof, for independently or collectively instructing or configuring a hardware device to operate as desired. Software and/or data may be embodied permanently or temporarily in any type of machine, component, physical or virtual equipment, or computer storage medium or device, or transmitted signal wave, capable of providing instructions or data to, or being interpreted by a processing device. The software also may be distributed over network coupled computer systems so that the software is stored and executed in a distributed fashion. Software and data may be stored on one or more computer readable media.

The method according to the embodiment of the present disclosure may be implemented in the form of program instructions that can be executed through various computer means and recorded in a computer readable medium. The computer readable recording medium may include program instructions, data files, data structures, etc. alone or in combination. Program instructions recorded on the medium may be those specially designed and configured for the present disclosure, or those known and usable to those skilled in the art of computer software. Examples of computer-readable recording media include magnetic media such as hard disks, floppy disks and magnetic tapes, optical recording media such as CD-(ROMs and DVDs, and magneto-optical media such as floptical disks. and hardware devices specially configured to store and execute program instructions, such as ROM, (RAM, flash memory, and the like. Examples of program instructions include high-level language codes that can be executed by a computer using an interpreter or the like as well as machine language codes generated by a compiler. The hardware device may be configured to act as one or more software modules to perform operation according to the present disclosure and vice versa.

The contents described above may be modified and changed by those skilled in the art without departing from the essential characteristics of the present disclosure. Therefore, the present disclosure is not intended to limit the technical idea of the present embodiment, but to explain, and the scope of the technical idea of the present disclosure is not limited by these embodiments. The scope of protection of the present disclosure should be interpreted according to the claims below, and all technical ideas within the scope equivalent thereto should be construed as being included in the scope of rights of the present disclosure.

What is claimed is:

1. A system for linking non-network sensor and equipment information collection in industrial site, the system comprising:
a field manager terminal configured access a web uniform resource locator (URL) by scanning a quick-response (QR) code attached to the non-network field equipment through an open application programming interface (API) and then provide QR code scan information and equipment management information obtained by photographing and recording management status including image and text of the non-network field equipment; and
a non-network field equipment information collection linkage server configured to be linked to an equipment data management system via a network and analyze and determine operation status and management status of the field equipment using a deep learning algorithm based on the equipment management information provided by the field manager terminal.

2. The system of claim 1, wherein the open API includes:
a camera shooting unit configured to link with a camera of the field manager terminal to support a function for improving quality of an image of the field equipment taken by the camera;
a QR scan recognition unit configured to scan the QR code attached to the field equipment and recognize global positioning system (GPS) coordinate information, resource information, and web URL address of the field equipment by the scan information;
a web access unit configured to access the web URL address recognized by the QR scan recognition unit and support a data transmission path between the field manager terminal and the non-network field equipment information collection linkage server;
a data input unit configured to support a function for entering management status information of the field equipment to which a QR code sticker is attached; and
a GPS location notification unit configured to display and notify a location of the field equipment located within a preset radius from a location of the field manager terminal.

3. The system of claim 1, wherein the non-network field equipment information collection linkage server includes:
a field equipment registration unit configured to register the type and GPS information of the non-network field equipment input by the field manager terminal;
a QR code generation and issuance unit configured to identify or recognize the non-network field equipment and generate and issue the QR code in which a URL, which is a data transmission path for transmitting management status information of the non-network field equipment, is recorded;
a field data linkage unit configured to collect identification information of the QR code attached to the non-network field equipment transmitted from the field manager terminal and management status information including image and text of the non-network field equipment;
a data organization and analysis unit configured to evaluate and analyze the management status of the non-network field equipment based on the management status information of the non-network field equipment collected by the field data linkage unit; and
a legacy system linkage unit configured to transmit the evaluation and analysis results of the data analysis unit to an equipment data management system.

4. The system of claim 2, wherein the field manager terminal prints the QR code issued by the QR code generation and issuance unit as a sticker.

5. The system of claim 4, wherein the QR code generation and issuance unit includes:
a QR code generation unit configured to generate a QR code in which GPS information and resource information of the field equipment registered in the field equipment registration book are recorded; and
a QR code issuance unit configured to issue the QR code generated by the QR code generation unit to the field manager terminal that manages the field equipment.

6. The system of claim 5, wherein the field data linkage unit includes
a data collection unit configured to collect the QR code scan information transmitted from the field manager terminal and management status information of the non-network field equipment;
a data verification unit configured to identify and verify field equipment GPS information and resource information in the QR code scan information collected by the data collection unit; and
a data classification unit configured to classify the management status information of the non-network field equipment into images and texts.

7. The system of claim 3, wherein the data organization and analysis unit includes:
an equipment list management unit that calls a field management list registered in the equipment data management system through the legacy system linkage unit;
a data analysis and determination configured to diagnose the normal or abnormal state of the field equipment based on a deep learning algorithm based on an image taken of the operation status or management status of the field equipment; and
an evaluation and diagnosis unit configured to comprehensively evaluate and diagnose the management status of the field equipment based on the analysis results of an image analysis and text analysis.

8. The system of claim 7, wherein the legacy system linkage unit is configured to transmit the comprehensive evaluation diagnosis results from the data organization and analysis unit to the equipment data management system, which is a legacy system, and,
when receiving the call of the equipment management list from the data analysis and determination unit, call and receive a field data linkage list from the linked equipment data management system, and transmit the equipment management list from the received field data linkage list to the data analysis and determination unit.

9. A method for operating a system for linking non-network sensor and equipment information collection in industrial site, the method comprising:
in a field manager terminal, accessing a web uniform resource locator by scanning a QR code attached to the non-network field equipment and then providing the QR code scan information and equipment management information obtained by photographing and recording management status including image and text of the non-network field equipment; and
in a non-network field equipment information collection linkage server, linking to an equipment data management system via a network and analyzing and determining operation status and management status of the field equipment using a deep learning algorithm based on the equipment management information provided by the field manager terminal, and then transmitting the result to the equipment data management system.
